(19) United States
(12) Patent Application Publication
(10) Pub. No.: US 2016/0092115 A1
(43) Pub. Date: Mar. 31, 2016

(54) IMPLEMENTING STORAGE POLICIES REGARDING USE OF MEMORY REGIONS

(71) Applicant: Hewlett-Packard Development Company, L. P., Houston, TX (US)

(72) Inventors: Binu J. Babu, Houston, TX (US); Ashkan Sotoodeh, Irving, TX (US)

(21) Appl. No.: 14/499,323

(22) Filed: Sep. 29, 2014

(51) Int. Cl. G06F 3/06

(52) U.S. Cl. CPC G06F 3/0611; G06F 3/0647; G06F 3/0688

(57) ABSTRACT

Example implementations relate to implementing storage policies regarding use of memory regions. In example implementations, a first memory region having a lower access latency than a second memory region may be identified. The first and second memory regions may be identical in memory type. A plurality of storage policies regarding use of the first and second memory regions may be implemented.

### BACKGROUND

Data used by active applications and processes may be stored in various regions of memory. The physical layout of a memory device may be such that some memory locations are closer than others to pads and/or periphery circuits. Memory locations near pads and/or periphery circuits of a memory device may have shorter data path lengths than memory locations that are farther away from pads and periphery circuits.

### BRIEF DESCRIPTION OF THE DRAWINGS

The following detailed description references the drawings, wherein:

FIG. 1 is an example system for implementing storage policies regarding use of memory regions;

FIG. 2 is an example system for reducing power consumed by memory;

FIG. 3 is a block diagram of an example system that includes a machine-readable storage medium encoded with instructions to enable dynamically changing a storage policy during runtime;

FIG. 4 is a block diagram of an example system that includes a machine-readable storage medium encoded with instructions to move data from one memory region to another;

FIG. 5 is a block diagram of an example system that includes a machine-readable storage medium encoded with instructions to enable reducing power consumed by memory;

FIG. 6 is a block diagram of an example system that includes a machine-readable storage medium encoded with instructions to enable increasing frequency of issued memory access commands;

FIG. 7 is a flowchart of an example method for implementing storage policies regarding use of memory regions; and

FIG. 8 is a flowchart of an example method for moving data in response to decreased memory demand.

### DETAILED DESCRIPTION

Thousands of memory cells may be fabricated on the same memory device. Due to process variations, different memory cells on the same chip may take different amounts of time to access. Access time may also vary due to physical location; memory cells near pads and/or periphery circuits of a memory device may have shorter data path lengths than memory cells that are farther away from pads and periphery circuits. Data may be accessed more quickly from memory cells having shorter data path lengths than from memory cells having longer path lengths. When data is stored randomly in various memory locations subject to different process variations and having different data path lengths, the speed at which data may be accessed may be limited by the slowest memory location. Additionally, data stored in volatile memory is periodically refreshed; use of more regions of memory leads to more refresh current being used. In light of the above, the present disclosure provides for concentrating storage of data in memory locations that may be accessed quickly, allowing data access commands to be issued more frequently and reducing the area of memory to be refreshed.

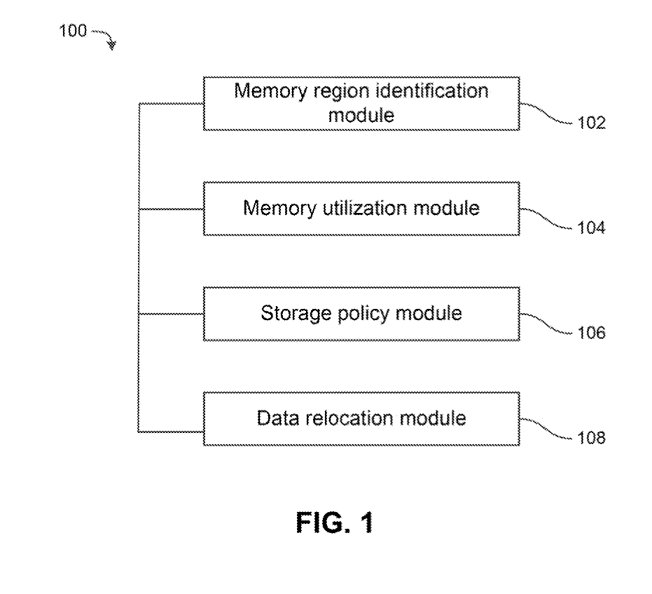

Referring now to the drawings, FIG. 1 is an example system 100 for implementing storage policies regarding use of memory regions. In some implementations, system 100 may be part of a server. In some implementations, system 100 may be part of an electronic user device, such as a notebook computer, a desktop computer, a workstation, a tablet computing device, a mobile phone, or an electronic book reader.

In FIG. 1, system 100 includes memory region identification module 102, memory utilization module 104, storage policy module 106, and data relocation module 108. As used herein, the terms “include”, “have”, and “comprise” are interchangeable and should be understood to have the same meaning. A module may include a set of instructions encoded on a machine-readable storage medium and executable by a processor. In addition or as an alternative, a module may include a hardware device comprising electronic circuitry for implementing the functionality described below.

Memory region identification module 102 may identify a first memory region having a lower access latency than a second memory region. As used herein with respect to a memory region, the phrase “access latency” should be understood to refer to a length of time from when an access command is issued to the memory region, to when data associated with the access command is available. An access command may be a read command or a write command. For example, the length of time from when a read command is issued to the first memory region, to when the first bit of data read from the first memory region (in response to the read command) becomes available, may be shorter than the corresponding length of time for a read command issued to the second memory region.

A memory region may be, for example, a group of rows or columns of memory, a memory bank, a subset of memory cells in a memory bank, or any suitable portion of memory. The first and second memory region may be the same size (e.g., physically and/or in terms of memory capacity), or may be different sizes. In some implementations, the first and second memory regions may be in a dynamic random-access memory (DRAM) device. For example, the first memory region may be in a memory bank that is physically adjacent to pads and/or periphery circuits of a DRAM device, and the second memory region may be in a different memory bank that is not physically adjacent to the pads and periphery circuits of the DRAM device.

The first and second memory regions may be identical in memory type. As used herein with respect to memory regions, the phrase “identical in memory type” should be understood to refer to memory regions that are manufactured using the same type of process. The first and second memory regions may have the same manufacturer (e.g., may be on the same memory device), or may have different manufacturers (e.g., two different DRAM manufacturers).

In some implementations, the first memory region and the second memory region may be on a memory module. The memory module may be an in-line memory module, such as a single in-line memory module (SIMM) or a dual in-line memory module (DIMM), or any memory module suitable for mounting memory integrated circuits (ICs). Memory region identification module 102 may read access latency data for the first memory region and the second memory region from a serial presence detect (SPD) read-only memory (ROM) on the memory module. The SPD ROM may include data about the physical layout of the memory module, including locations of various memory banks, pads, and periphery circuits. Memory region identification module 102 may use such physical layout data to identify a memory region physically adjacent to pads and/or periphery circuits as the first memory region, and identify a memory region that is not physically adjacent to pads and periphery circuits as the second memory region. In some implementations, the SPD ROM may include data for average access latencies of various regions of the memory module, and memory region identification module 102 may identify the first and second memory regions based on such average access latency data.

In some implementations, the first memory region and the second memory region may be on a memory device. Memory region identification module 102 may identify, based on characteristics of the memory device, the first memory region. Characteristics of the memory device may include, for example, the device manufacturer or vendor, and physical locations of components of the memory device. In some implementations, memory region identification module 102 may determine a manufacturer/vendor of a particular memory device, retrieve data regarding physical layouts of memory devices made by various manufacturers/vendors, and determine which physical layout corresponds to the particular memory device. Memory region identification module 102 may then identify a memory region physically adjacent to pads and/or periphery circuits on the memory device as the first memory region, and identify a memory region that is not physically adjacent to pads and periphery circuits as the second memory region.

Memory utilization module 104 may determine memory demand. Memory demand may be the amount of memory used by processes, applications, hardware, etc. that have access to the first and second memory regions. During boot time, for example, memory utilization module 104 may determine how much memory will be used by processes, applications, and/or hardware (e.g., hard drive, central processing unit (CPU)) that will be running or utilized at the beginning of runtime. During runtime, memory utilization module 104 may receive data from an operating system (OS) regarding how much memory is needed by processes/applications that are running.

Storage policy module 106 may implement a plurality of storage policies regarding use of the first and second memory regions. As used herein, the phrase “storage policy” should be understood to refer to an access scheme that dictates to which memory regions a memory controller directs access commands. According to some storage policies, a memory controller may direct access commands to a certain memory region (or set of memory regions) and not to other memory regions. For example, a memory controller may direct read and write commands to a certain memory region, and may not direct any read and write commands to other memory regions (i.e., the memory controller uses a smaller portion of memory than is available). Storage policy module 106 may implement one storage policy at a time, but may be able to change which storage policy is implemented at various times during runtime. For example, storage policy module 106 may implement a certain storage policy (e.g., by default or in response a user selection) during boot time, and the same storage policy may be implemented for the entirety of runtime, or the implemented storage policy may change during runtime.

In some implementations, storage policy module 106 may implement, in response to a runtime determination (e.g., made by memory utilization module 104) that memory demand is below a threshold value, a different storage policy of the plurality of storage policies instead of a currently implemented storage policy. For example, storage policy module 106 may initially implement a first storage policy according to which the first and second memory regions are both used (e.g., the memory controller directs some access commands to the first memory region and some access commands to the second memory region). The threshold value may be equal to the memory capacity of the first memory region, or a value less than the memory capacity of the first memory region. At some point during runtime, storage policy module 106 may receive an indication from an OS that the amount of memory needed by processes/applications that are running is less than the threshold value, or determine based on data received from the OS that this is the case. In response to receiving the indication, storage policy module 106 may implement a second storage policy, according to which the first memory region is used and no other memory regions are used (e.g., the memory controller directs all access commands to the first memory region and does not direct any access commands to other memory regions), instead of the first storage policy. If memory demand rises above the threshold value later on during runtime (i.e., processes/applications that are running need more memory than is in the first memory region), storage policy module 106 may switch back to implementing the first storage policy (e.g., after receiving an indication from the OS that the amount of memory needed by processes/applications that are running is greater than the threshold value, or determining based on data received from the OS that this is the case).

When memory demand is less than the capacity of the first memory region, the first memory region may be used exclusively. If the first memory region has a lower access latency than any other region, memory access commands may be issued more frequently when only the first memory region is used than when other memory regions are used along with the first memory region. Thus, processes may run more quickly and overall system performance may be increased when the second storage policy is implemented instead of the first storage policy.

In some implementations, storage policy module 106 may implement a storage policy, according to which some memory regions are excluded from use, by masking a bit of memory addresses. For example memory addresses in the first memory region may all have the same most significant bit (MSB), and memory addresses in the second memory region may have an MSB that is different from that of memory addresses in the first memory region. To implement a storage policy according to which the first memory region is used to the exclusion of the second memory region, storage policy module 106 may apply a mask to memory addresses that a memory controller specifies, to force the MSB of such memory addresses to be the same as that of memory addresses in the first memory region. A mask bit may be stored in a register of a memory controller. It should be understood that multi-bit masks for memory addresses may be used to target the appropriate region of memory.

It should be understood that memory region identification module 102 may identify more than two regions of memory, and that storage policies implemented by storage policy module 106 may involve other memory regions instead of or in addition to the first and second memory regions. The concepts discussed herein may be applicable to any number of additional identified memory regions and storage policies. For example, memory region identification module 102 may identify a third memory region having an access latency different from those of the first and second memory regions. The first, second, and third memory regions may be identical in memory type. Storage policy module 106 may implement a third storage policy, of the plurality of storage policies, regarding use of the first, second, and third memory regions. For example, the third memory region may have an access latency lower than those of the first and second memory regions, and according to the third storage policy, a memory controller may direct access commands to the third memory region and not to the first and second memory regions. If memory demand is lower than the memory capacity of the third memory region, storage policy module 106 may implement the third storage policy.

In some implementations, storage policy module 106 may receive, during runtime of system 100, and while storage policy module 106 is implementing a first storage policy of the plurality of storage policies, a storage policy change command. In response to the storage policy change command, storage policy module 106 may implement a second storage policy of the plurality of storage policies, and stop implementing the first storage policy. In some implementations, the storage policy change command may be received from an OS. For example, while a first storage policy, according to which both the first and second memory regions are used, is implemented, the OS may determine that memory demand is below a certain threshold (e.g., less than the memory capacity of the first memory region), and may send a storage policy change command to implement a second storage policy, according to which the first memory region is used to the exclusion of other memory regions.

In some implementations, a storage policy change command may be received from a user. For example, a user may press a key/button or flip a switch on a user device to indicate a desire for faster performance. In some implementations, a user may indicate on a sliding scale (e.g., slider bar in a control panel display) how much memory should be used or what level of performance is desired, the amount of memory used being inversely proportional to level of performance. In response to the user input, storage policy module 106 may implement the appropriate storage policy for the desired amount of memory usage or level of performance (e.g., if the user indicates that more memory is to be used, the implemented storage policy may be changed to one according to which more memory regions to be used).

Data relocation module 108 may move, in response to a runtime determination that memory demand is below a threshold value, data from the second memory region to the first memory region. For example, applications/processes that are running may use some memory addresses in the first memory region and some memory addresses in the second memory region (e.g., because under a currently implemented storage policy, a memory controller directs some access commands to the first memory region and some access commands to the second memory region), but memory utilization module 104 may determine that memory demand is below a threshold value equal to the memory capacity of the first memory region. Data relocation module 108 may move/copy data from the second memory region to unused locations in the first memory region, allowing the first memory region to be used to the exclusion of the second memory region, and thus allowing memory access commands to be issued more frequently and improving system performance.

In some implementations, according to a first storage policy, memory access commands may be directed at the first memory region and the second memory region. According to a second storage policy, memory access commands may be directed at the first memory region and not at the second memory region. Data relocation module 108 may move data from the second memory region to the first memory region in response to the storage policy change command. The storage policy change command may be received from an OS or from a user, as discussed above.

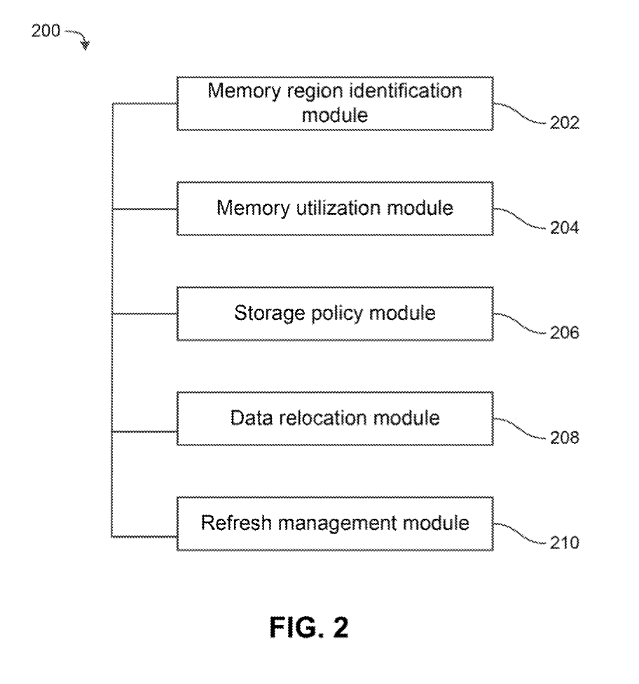

FIG. 2 is an example system 200 for reducing power consumed by memory. In some implementations, system 200 may be part of a server. In some implementations, system 200 may be part of an electronic user device, such as a notebook computer, a desktop computer, a workstation, a tablet computing device, a mobile phone, or an electronic book reader.

In FIG. 2, system 200 includes memory region identification module 202, memory utilization module 204, storage policy module 206, data relocation module 208, and refresh management module 210. A module may include a set of instructions encoded on a machine-readable storage medium and executable by a processor. In addition or as an alternative, a module may include a hardware device comprising electronic circuitry for implementing the functionality described below.

Modules 202, 204, 206, and 208 of FIG. 2 may be analogous to (e.g., have functions and/or components similar to) modules 102, 104, 106, and 108, respectively, of FIG. 1. Data relocation module 208 may move data from a second memory region to a first memory region (e.g., in response to a determination that memory demand is below a threshold, or in response to a storage policy change command, as discussed above with respect to FIG. 1), the first memory region having a lower access latency than the second memory region. The first and second memory regions may be identical in memory type. Refresh management module 210 may disable refresh cycles in the second memory region in response to a determination that copying of data from the second memory region to the first memory region is complete. For example, refresh management module 210 may intercept or block refresh commands directed at the second memory region, and/or disable refresh circuitry for the second memory region.

In some implementations, refresh management module 210 may disable refresh cycles in memory regions to which, according to the currently implemented storage policy, access commands are not directed (e.g., memory regions to which the memory controller does not issue read and write commands according to the implemented storage policy). For example, refresh management module 210 may determine, in response to a storage policy change command, which memory regions are not used according to the new storage policy that is implemented, and disable refresh cycles for those memory regions after their data has been copied/moved to a memory region that is used according to the new storage policy that is implemented. Thus, refresh current and memory refresh time may be reduced, reducing power consumption and increasing overall system performance.

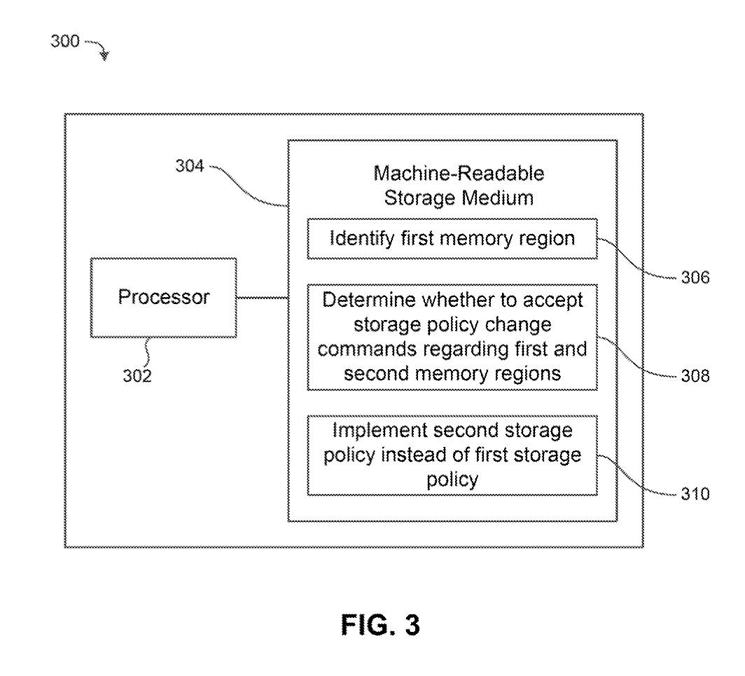

FIG. 3 is a block diagram of an example system 300 that includes a machine-readable storage medium encoded with instructions to enable dynamically changing a storage policy during runtime. In some implementations, system 300 may be part of a server. In some implementations, system 300 may be part of an electronic user device, such as a notebook computer, a desktop computer, a workstation, a tablet computing device, a mobile phone, or an electronic book reader. In FIG. 3, system 300 includes processor 302 and machine-readable storage medium 304.

Processor 302 may include a CPU, microprocessor (e.g., semiconductor-based microprocessor), and/or other hardware device suitable for retrieval and/or execution of instructions stored in machine-readable storage medium 304. Processor 302 may fetch, decode, and/or execute instructions 306, 308, and 310 to enable dynamically changing a storage policy during runtime, as described below. As an alternative or in addition to retrieving and/or executing instructions, processor 302 may include an electronic circuit comprising a number of electronic components for performing the functionality of instructions 306, 308, and/or 310.

Machine-readable storage medium 304 may be any suitable electronic, magnetic, optical, or other physical storage device that contains or stores executable instructions. Thus, machine-readable storage medium 304 may include, for example, a RAM, an Electrically Erasable Programmable Read-Only Memory (EEPROM), a storage device, an optical disc, and the like. In some implementations, machine-readable storage medium 304 may include a non-transitory storage medium, where the term “non-transitory” does not encompass transitory propagating signals. As described in detail below, machine-readable storage medium 304 may be encoded with a set of executable instructions 306, 308, and 310.

Instructions 306 may identify a first memory region having a lower access latency than a second memory region. The first and second memory regions may be identical in memory type. The first memory region may be identified based on data about the physical layout of a memory module (e.g., read from an SPD ROM), or based on characteristics of a memory device, as discussed above with respect to FIG. 1.

Instructions 308 may determine whether to accept storage policy change commands, regarding use of the first and second memory regions, that are received during runtime. For example, during boot time, a Basic Input/Output System (BIOS) may prompt a user for an input indicating whether storage policy change commands received during runtime should be accepted. In some implementations, the BIOS may be programmed to either accept or not accept storage policy change commands received during runtime. If storage policy change commands are not to be accepted during runtime, the storage policy to be implemented during runtime may be determined (e.g., by default or by user selection) during boot time and may remain the same throughout all of runtime (e.g., storage policy change commands may be ignored). If storage policy change commands are to be accepted during runtime, the implemented storage policy may change during runtime in response to storage policy change commands received from an OS and/or a user, as discussed above with respect to FIG. 1.

Instructions 310 may implement, if a storage policy change command is received while a first storage policy is implemented, and if a determination is made to accept storage policy change commands that are received during runtime, a second storage policy instead of the first storage policy. For example, according to the first storage policy, memory access commands may be directed at the first memory region and the second memory region, and according to the second storage policy, memory access commands may be directed at the first memory region and not at the second memory region. In some implementations, an address bit may be masked to implement a storage policy according to which one memory region is used to the exclusion of another, as discussed above with respect to FIG. 1.

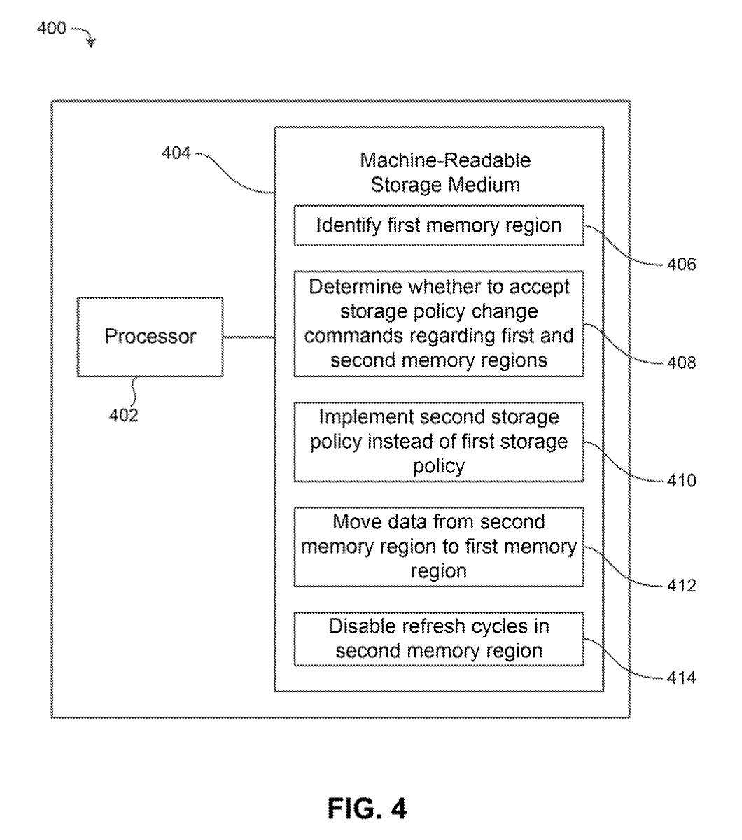

FIG. 4 is a block diagram of an example system 400 that includes a machine-readable storage medium encoded with instructions to move data from one memory region to another. In some implementations, system 400 may be part of a server. In some implementations, system 400 may be part of an electronic user device, such as a notebook computer, a desktop computer, a workstation, a tablet computing device, a mobile phone, or an electronic book reader. In FIG. 4, system 400 includes processor 402 and machine-readable storage medium 404.

As with processor 302 of FIG. 3, processor 402 may include a CPU, microprocessor (e.g., semiconductor-based microprocessor), and/or other hardware device suitable for retrieval and/or execution of instructions stored in machine-readable storage medium 404. Processor 402 may fetch, decode, and/or execute instructions 406, 408, 410, 412, and 414. As an alternative or in addition to retrieving and/or executing instructions, processor 402 may include an electronic circuit comprising a number of electronic components for performing the functionality of instructions 406, 408, 410, 412, and/or 414.

As with machine-readable storage medium 304 of FIG. 3, machine-readable storage medium 404 may be any suitable physical storage device that stores executable instructions. Instructions 406, 408, and 410 on machine-readable storage medium 404 may be analogous to instructions 306, 308, and 310, respectively, on machine-readable storage medium 304. In some implementations, according to a first storage policy, memory access commands may be directed at a first memory region and a second memory region, the first memory region having a lower access latency than the second memory region. The first and second memory regions may be identical in memory type. According to a second storage policy, memory access commands may be directed at the first memory region and not at the second memory region. Instructions 412 may move data from the second memory region to the first memory region in response to a storage policy change command. The storage policy change command may cause the second storage policy to be implemented instead of the first storage policy. Moving data from the second memory region to the first memory region may allow the first memory region to be used to the exclusion of the second memory region, and thus allow memory access commands to be issued more frequently, improving system performance.

Instructions 414 may disable refresh cycles in the second memory region in response to a determination that copying of data from the second memory region to the first memory region is complete. For example, instructions 414 may intercept or block refresh commands directed at the second memory region, and/or disable refresh circuitry for the second memory region. Disabling refresh cycles in the second memory region and/or other unused memory regions according to an implemented storage policy may reduce refresh current and memory refresh time, reducing power consumption and increasing overall system performance.

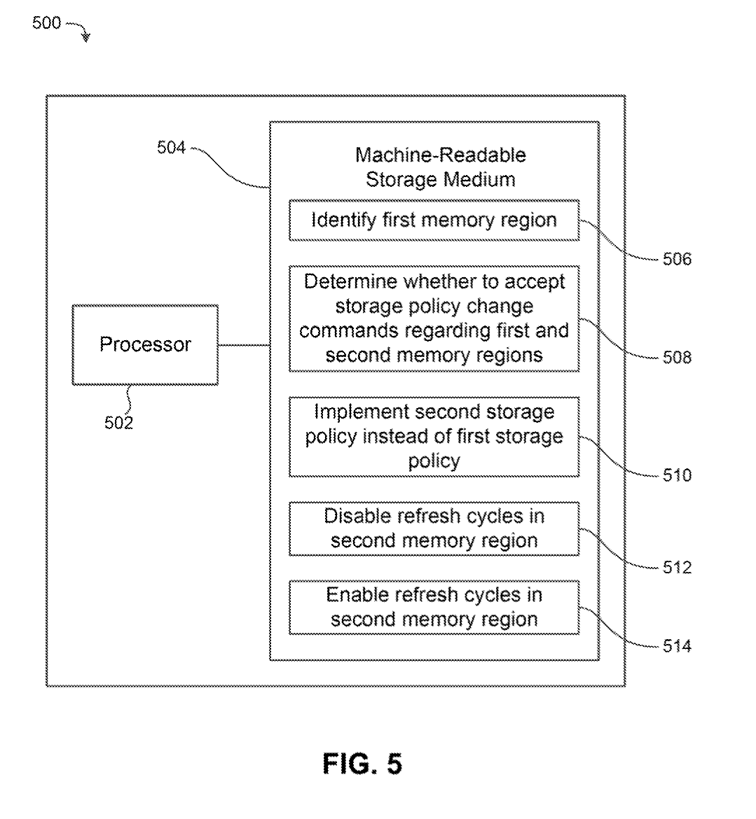

FIG. 5 is a block diagram of an example system 500 that includes a machine-readable storage medium encoded with instructions to enable reducing power consumed by memory. In some implementations, system 500 may be part of a server. In some implementations, system 500 may be part of an electronic user device, such as a notebook computer, a desktop computer, a workstation, a tablet computing device, a mobile phone, or an electronic book reader. In FIG. 5, system 500 includes processor 502 and machine-readable storage medium 504.

As with processor 302 of FIG. 3, processor 502 may include a CPU, microprocessor (e.g., semiconductor-based microprocessor), and/or other hardware device suitable for retrieval and/or execution of instructions stored in machine-readable storage medium 504. Processor 502 may fetch, decode, and/or execute instructions 506, 508, 510, 512, and 514 to enable reducing power consumed by memory, as described below. As an alternative or in addition to retrieving and/or executing instructions, processor 502 may include an electronic circuit comprising a number of electronic components for performing the functionality of instructions 506, 508, 510, 512, and/or 514.

As with machine-readable storage medium 304 of FIG. 3, machine-readable storage medium 504 may be any suitable physical storage device that stores executable instructions. Instructions 506, 508, and 510 on machine-readable storage medium 504 may be analogous to instructions 306, 308, and 310, respectively, on machine-readable storage medium 304. In some implementations, according to a first storage policy, memory access commands may be directed at a first memory region and not at a second memory region, the first memory region having a lower access latency than the second memory region. The first and second memory regions may be identical in memory type. According to the second storage policy, memory access commands may be directed at the first memory region and the second memory region. Instructions 512 may disable refresh cycles in the second memory region while the first storage policy is implemented. For example, instructions 512 may intercept or block refresh commands directed at the second memory region, and/or disable refresh circuitry for the second memory region.

Instructions 514 may enable refresh cycles in the second memory region while the second storage policy is implemented. For example, the second storage policy may be implemented and the first storage policy may stop being implemented if the memory demand of processes/applications that are running exceeds the memory capacity of the first memory region. When the second storage policy is implemented instead of the first storage policy, instructions 514 may unblock or stop intercepting refresh commands directed at the second memory region, and/or enable refresh circuitry for the second memory that was disabled while the first storage policy was implemented.

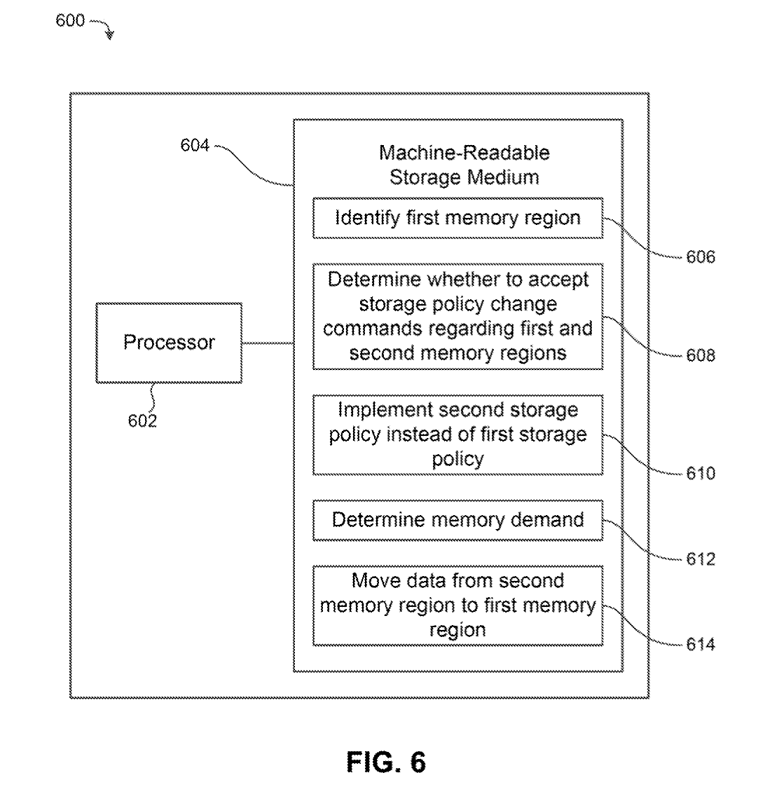

FIG. 6 is a block diagram of an example system 600 that includes a machine-readable storage medium encoded with instructions to enable increasing frequency of issued memory access commands. In some implementations, system 600 may be part of a server. In some implementations, system 600 may be part of an electronic user device, such as a notebook computer, a desktop computer, a workstation, a tablet computing device, a mobile phone, or an electronic book reader. In FIG. 6, system 600 includes processor 602 and machine-readable storage medium 604.

As with processor 302 of FIG. 3, processor 602 may include a CPU, microprocessor (e.g., semiconductor-based microprocessor), and/or other hardware device suitable for retrieval and/or execution of instructions stored in machine-readable storage medium 604. Processor 602 may fetch, decode, and/or execute instructions 606, 608, 610, 612, and 614 to enable increasing frequency of issued memory access commands, as described below. As an alternative or in addition to retrieving and/or executing instructions, processor 602 may include an electronic circuit comprising a number of electronic components for performing the functionality of instructions 606, 608, 610, 612, and/or 614.

As with machine-readable storage medium 304 of FIG. 3, machine-readable storage medium 604 may be any suitable physical storage device that stores executable instructions. Instructions 606, 608, and 610 on machine-readable storage medium 604 may be analogous to instructions 306, 308, and 310, respectively, on machine-readable storage medium 304. Instructions 612 may determine memory demand. For example, instructions 612 may determine, during boot time, how much memory will be used by processes, applications, and/or hardware (e.g., hard drive, CPU) that will be running or utilized at the beginning of runtime, or may receive data from an OS during runtime regarding how much memory is needed by processes/applications that are running, as discussed above with respect to FIG. 1.

Instructions 614 may move, during runtime, and in response to a determination that memory demand is below a threshold value, data from a second memory region to a first memory region, the first memory region having a lower access latency than the second memory region. The first and second memory regions may be identical in memory type. In some implementations, the threshold value may be equal to, or less than, the memory capacity of the first memory region, as discussed above with respect to FIG. 1. Moving/Copying data from the second memory region to unused locations in the first memory region may allow the first memory region to be used to the exclusion of the second memory region, thus allowing memory access commands to be issued more frequently and improving system performance.

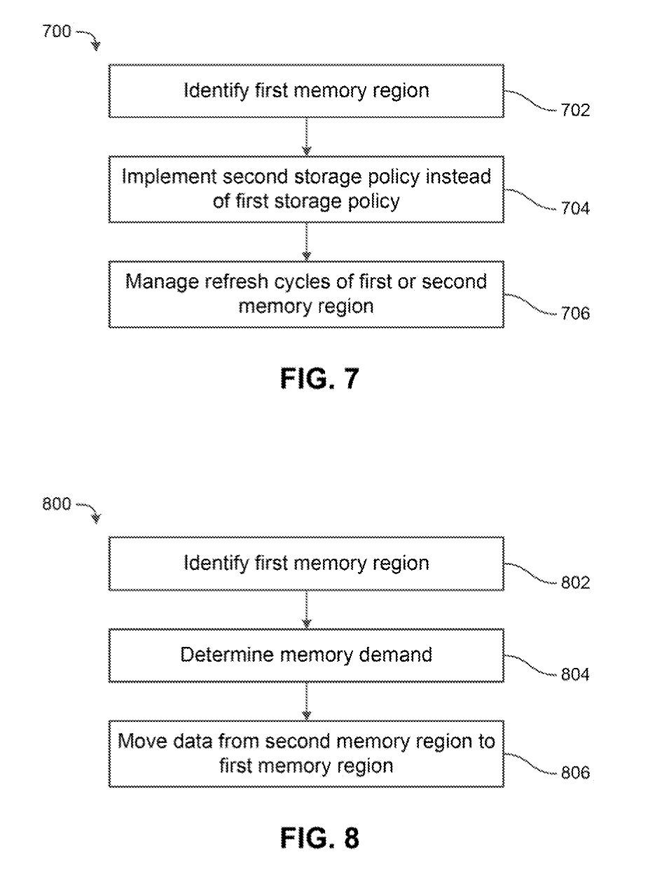

Methods related to increasing memory performance are discussed with respect to FIGS. 7-8. FIG. 7 is a flowchart of an example method 700 for implementing storage policies regarding use of memory regions. Although execution of method 700 is described below with reference to processor 502 of FIG. 5, it should be understood that execution of method 700 may be performed by other suitable devices, such as processors 302, 402, and 602 of FIGS. 3, 4, and 6, respectively. Method 700 may be implemented in the form of executable instructions stored on a machine-readable storage medium and/or in the form of electronic circuitry.

Method 700 may start in block 702, where processor 502 may identify a first memory region having a lower access latency than a second memory region. The first and second memory regions may be identical in memory type. In some implementations, the first memory region and the second memory region may be on a memory module. Identifying the first memory region may include reading access latency data for the first memory region and the second memory region from an SPD ROM on the memory module, as discussed above with respect to FIG. 1. In some implementations, the first memory region and the second memory region may be on a memory device. The first memory region may be identified based on characteristics of the memory device, as discussed above with respect to FIG. 1.

In block 704, processor 502 may implement, in response to a runtime storage policy change command received while a first storage policy regarding use of the first and second memory regions is implemented, a second storage policy, regarding use of the first and second memory regions, instead of the first storage policy. For example, according to the first storage policy, memory access commands may be directed at the first memory region and the second memory region, and according to the second storage policy, memory access commands may be directed at the first memory region and not at the second memory region. Implementing the second storage policy may include, in some instances, masking a bit of memory addresses, to which memory access commands are directed, to exclude memory addresses in the second memory region, as discussed above with respect to FIG. 1.

In some implementations, processor 502 may determine whether to accept storage policy change commands that are received during runtime, as discussed above with respect to FIG. 3. If a determination is made to accept storage policy change commands that are received during runtime, a different storage policy from a currently implemented storage policy may be implemented, instead of the currently implemented storage policy, in response to a storage policy change command received during runtime. If, according to the newly implemented storage policy, memory access commands are directed at the first memory region and not at the second memory region, processor 502 may move data from the second memory region to the first memory region in response to a storage policy change command received during runtime.

In block 706, processor 502 may manage refresh cycles of the first or second memory region in response to the storage policy change command. Managing refresh cycles may include disabling refresh cycles (e.g., intercepting/blocking refresh commands directed at a particular memory region, and/or disabling refresh circuitry) in memory regions to which, according to the currently implemented storage policy, access commands are not directed, as discussed above with respect to FIG. 2. For example, according to the first storage policy, memory access commands may be directed at the first memory region and not at the second memory region. According to the second storage policy, memory access commands may be directed at the first memory region and the second memory region. Managing refresh cycles may include disabling refresh cycles in the second memory region while the first storage policy is implemented, and enabling refresh cycles in the second memory region while the second storage policy is implemented.

FIG. 8 is a flowchart of an example method 800 for moving data in response to decreased memory demand. Although execution of method 800 is described below with reference to processor 602 of FIG. 6, it should be understood that execution of method 800 may be performed by other suitable devices, such as processors 302, 402, and 502 of FIGS. 3, 4, and 5, respectively. Some blocks of method 800 may be performed in parallel with and/or after method 700. Method 800 may be implemented in the form of executable instructions stored on a machine-readable storage medium and/or in the form of electronic circuitry.

Method 800 may start in block 802, where processor 602 may identify a first memory region having a lower access latency than a second memory region. The first and second memory regions may be identical in memory type. Processor 602 may identify the first memory region based on data about the physical layout of a memory module (e.g., read from an SPD ROM), or based on characteristics of a memory device, as discussed above with respect to FIG. 1.

In block 804, processor 602 may determine memory demand. For example, processor 602 may determine, during boot time, how much memory will be used by processes, applications, and/or hardware (e.g., hard drive, CPU) that will be running or utilized at the beginning of runtime, or may receive data from an OS during runtime regarding how much memory is needed by processes/applications that are running, as discussed above with respect to FIG. 1.

In block 806, processor 602 may move, during runtime, and in response to a determination that memory demand is below a threshold value, data from the second memory region to the first memory region. In some implementations, the threshold value may be equal to, or less than, the memory capacity of the first memory region, as discussed above with respect to FIG. 1. Moving/Copying data from the second memory region to unused locations in the first memory region may allow the first memory region to be used to the exclusion of the second memory region, thus allowing memory access commands to be issued more frequently.

The foregoing disclosure describes implementing storage policies regarding use of memory regions. Example implementations described herein enable increased speed of memory access and reduced power consumption, improving overall system performance.

We claim:

1. A system comprising:
a memory region identification module to identify a first memory region having a lower access latency than a second memory region, wherein the first and second memory regions are identical in memory type;
a memory utilization module to determine memory demand;
a storage policy module to implement a plurality of storage policies regarding use of the first and second memory regions; and
a data relocation module to move, in response to a runtime determination that memory demand is below a threshold value, data from the second memory region to the first memory region.

2. The system of claim 1, wherein:
the first memory region and the second memory region are on a memory module; and
the memory region identification module is further to read access latency data for the first memory region and the second memory region from a serial presence detect (SPD) read-only memory (ROM) on the memory module.

3. The system of claim 1, wherein:
the first memory region and the second memory region are on a memory device; and
the memory region identification module is to identify, based on characteristics of the memory device, the first memory region.

4. The system of claim 1, wherein the storage policy module is further to:
receive, during runtime of the system, and while the storage policy module is implementing a first storage policy of the plurality of storage policies, a storage policy change command; and
in response to the storage policy change command:
implement a second storage policy of the plurality of storage policies, and
stop implementing the first storage policy.

5. The system of claim 4, wherein:
according to the first storage policy, memory access commands are directed at the first memory region and the second memory region;
according to the second storage policy, memory access commands are directed at the first memory region and not at the second memory region; and
the data relocation module is further to move data from the second memory region to the first memory region in response to the storage policy change command.

6. The system of claim 1, further comprising a refresh management module to disable refresh cycles in the second memory region in response to a determination that copying of data from the second memory region to the first memory region is complete.

7. The system of claim 1, wherein:
the memory region identification module is further to identify a third memory region having an access latency different from those of the first and second memory regions, wherein the first, second, and third memory regions are identical in memory type; and
the storage policy module is further to implement a third storage policy, of the plurality of storage policies, regarding use of the first, second, and third memory regions.

8. The system of claim 1, wherein the storage policy module is further to implement, in response to the runtime determination that memory demand is below the threshold value, a different storage policy of the plurality of storage policies instead of a currently implemented storage policy.

9. A machine-readable storage medium encoded with instructions executable by a processor, the machine-readable storage medium comprising:
instructions to identify a first memory region having a lower access latency than a second memory region, wherein the first and second memory regions are identical in memory type;
instructions to determine whether to accept storage policy change commands, regarding use of the first and second memory regions, that are received during runtime; and
instructions to implement, if a storage policy change command is received while a first storage policy is implemented, and if a determination is made to accept storage policy change commands that are received during runtime, a second storage policy instead of the first storage policy.

10. The machine-readable storage medium of claim 9, wherein:
according to the first storage policy, memory access commands are directed at the first memory region and the second memory region;
according to the second storage policy, memory access commands are directed at the first memory region and not at the second memory region; and
the machine-readable storage medium further comprises instructions to move data from the second memory region to the first memory region in response to the storage policy change command.

11. The machine-readable storage medium of claim 10, further comprising instructions to disable refresh cycles in the second memory region in response to a determination that copying of data from the second memory region to the first memory region is complete.

12. The machine-readable storage medium of claim 9, wherein:
according to the first storage policy, memory access commands are directed at the first memory region and not at the second memory region;
according to the second storage policy, memory access commands are directed at the first memory region and the second memory region; and
the machine-readable storage medium further comprises:
instructions to disable refresh cycles in the second memory region while the first storage policy is implemented; and
instructions to enable refresh cycles in the second memory region while the second storage policy is implemented.

13. The machine-readable storage medium of claim 9, further comprising:
instructions to determine memory demand; and
instructions to move, during runtime, and in response to a determination that memory demand is below a threshold value, data from the second memory region to the first memory region.

14. A method comprising:
identifying a first memory region having a lower access latency than a second memory region, wherein the first and second memory regions are identical in memory type;
implementing, in response to a runtime storage policy change command received while a first storage policy regarding use of the first and second memory regions is implemented, a second storage policy, regarding use of the first and second memory regions, instead of the first storage policy; and
managing refresh cycles of the first or second memory region in response to the storage policy change command.

15. The method of claim 14, further comprising determining whether to accept storage policy change commands that are received during runtime, wherein:
according to the first storage policy, memory access commands are directed at the first memory region and the second memory region;
according to the second storage policy, memory access commands are directed at the first memory region and not at the second memory region; and
implementing the second storage policy comprises masking a bit of memory addresses, to which memory access commands are directed, to exclude memory addresses in the second memory region.

16. The method of claim 15, further comprising moving data from the second memory region to the first memory region in response to the storage policy change command.

17. The method of claim 14, wherein:
according to the first storage policy, memory access commands are directed at the first memory region and not at the second memory region;
according to the second storage policy, memory access commands are directed at the first memory region and the second memory region; and
managing refresh cycles comprises:
disabling refresh cycles in the second memory region while the first storage policy is implemented; and
enabling refresh cycles in the second memory region while the second storage policy is implemented.

18. The method of claim 14, further comprising:
determining memory demand; and
moving, during runtime, and in response to a determination that memory demand is below a threshold value, data from the second memory region to the first memory region.

19. The method of claim 14, wherein:
the first memory region and the second memory region are on a memory module; and
identifying the first memory region comprises reading access latency data for the first memory region and the second memory region from a serial presence detect (SPD) read-only memory (ROM) on the memory module.

20. The method of claim 14, wherein:
the first memory region and the second memory region are on a memory device; and
the first memory region is identified based on characteristics of the memory device.
